(19) United States
(12) Patent Application Publication
(10) Pub. No.: US 2005/0206791 A1
(43) Pub. Date: Sep. 22, 2005

(54) Apparatus for injecting electrical signals into lines or cables for location purposes

(76) Inventor: Michael Kurth, Eningen u. A. (DE)

Correspondence Address: STAAS & HALSEY LLP, SUITE 700, 1201 NEW YORK AVENUE, N.W., WASHINGTON, DC, 20005, US

(21) Appl. No.: 11/082,789

(22) Filed: Mar. 18, 2005

(30) Foreign Application Priority Data
Mar. 18, 2004 (DE) 102004013492.8-35

(51) Int. Cl. H04N 11/02

(52) U.S. Cl. 348/729; 348/755

(57) ABSTRACT

The apparatus fitted in a hand-portable test unit has means (1) for generating an electrical signal by modulating a relatively higher-frequency signal with a relatively low-frequency audio signal and means for injecting the signal into one end of a line. Superimposing the higher-frequency carrier frequency on the low-frequency audio frequency makes it possible to design the output capacitors (3.1, 3.2, 3.3, 3.4) to have a smaller capacitance, with the result that the dielectric strength of the device can be increased.

The present invention relates to an apparatus for injecting electrical signals into lines or cables for location purposes, to a hand-portable test unit containing this apparatus, to an apparatus, comprising the former apparatus, for checking cabling and to a use of the apparatus for checking cabling.

When laying and checking electrical cables or telephone lines and the like, it is necessary to locate cables which have already been laid and are, for example, under plaster and to ascertain their course. To this end, a multiplicity of cable search or locating apparatuses which can be used to locate current-carrying cables by detecting their electrical and/or magnetic fields have, in the meantime, become available on the market. In this case, an electrical signal is fed into one end of a cable that is to be checked and has been laid behind a wall, and a probe that is moved over the wall is used to inductively and/or capacitively detect and evaluate a signal that has been output from the cable.

Some apparatuses of the type described comprise an audio-frequency generator (“toner”) in the form of a hand-held unit and an audio-frequency receiver (“probe”), likewise in the form of a hand-held unit. The audio-frequency generator transmits an alternating current signal at an audio frequency onto the line and the audio-frequency receiver that has been set to the audio frequency uses its probe to locate the signal that has been output from the cable and uses a loudspeaker to make said signal audible, with the result that the loudness of the sound emitted by the loudspeaker, which loudness changes with the position of the probe on the wall, can be used to effect the locating operation.

The devices known hitherto can already be used to locate a line in a relatively rapid and simple manner if the line has been laid in a simple manner. In practice, however, the situation in which a plurality of lines run at a comparatively small distance next to one another is occurring more frequently. Although the audio-frequency signal from the audio-frequency generator has been injected into only one line or line pair, the audio-frequency receiver may incorrectly locate the latter on account of the physical proximity and as a result of crosstalk between the lines.

Sufficiently protecting devices of this type against high voltage is a perpetual problem with said devices. The audio-frequency signal, which is usually in a frequency range from 500 Hz to 3 kHz, is generated in the audio-frequency generator and is coupled to the line to be tested by means of output capacitors. Due to the low frequency of the audio-frequency signal, the capacitances of these output capacitors, which capacitances are required for efficient output, are currently usually in the region of 1 uF (an output capacitor of 0.47 uF is used when outputting a 1 kHz signal). These relatively high capacitances mean that the device becomes susceptible to damage or destruction when the test cables inadvertently touch the current-carrying line network with its 220-380 V alternating current at 50 Hz. The devices known hitherto as overvoltage protection, for example relay circuits for isolating the output capacitor from the internal circuitry in the event of overvoltage, do not constitute an optimum solution to the problem for various reasons, in particular on account of the additional hardware complexity.

Therefore, one object of the present invention is to specify an apparatus for injecting electrical signals into lines or cables for test purposes, which apparatus is protected against overvoltages in a simpler and more effective manner. A further object of the invention is to improve the pinpointing of individual lines or line pairs in the case of a plurality of closely adjacent lines.

These objects are achieved by means of the characterizing features of patent claim 1. Advantageous refinements and developments are specified in the coordinate patent claims and the subclaims.

The present invention therefore relates to an apparatus, such as an audio-frequency generator described at the outset, for injecting electrical signals into lines or cables for location purposes, an apparatus of this type now being characterized by
means for generating an electrical signal by modulating a relatively higher-frequency signal with a relatively low-frequency signal, and
means for injecting the signal into one end of a line.

A corresponding method according to the invention comprises the steps of generating an electrical signal by modulating a relatively higher-frequency signal with a relatively low-frequency signal and injecting the signal into one end of a line to be located.

In this case, the relatively low-frequency signal may be an audio-frequency signal, as has been used hitherto. However, by now using this audio-frequency signal only as a modulation signal for a higher-frequency signal, it is possible to design the capacitance of the output capacitors (which are used to inject the superimposed signal into the electrical line) to be considerably smaller. When overvoltages occur, the device is no longer damaged or destroyed at all on account of these low coupling capacitances. Overvoltage protection of up to 380 V AC (50 Hz) can thus be achieved without having to provide additional hardware such as relay circuits which decouple the internal circuitry from the output in the event of overvoltage.

In this case, various types of modulation such as amplitude modulation, phase modulation or frequency modulation may be selected, at least in principle. However, the most advantageous variant is to amplitude modulate the higher-frequency signal using the low-frequency signal. It is furthermore advantageous if the low-frequency signal is in the form of a square wave, so that the higher-frequency signal is injected and blanked in time with the square-wave frequency of the low-frequency signal. In addition or as an alternative to this, the higher-frequency signal may also be formed by a square-wave signal.

The low-frequency signal is preferably an audio-frequency signal, that is to say it preferably has a frequency which, relative to the audible frequency spectrum, is in the audible range, in particular in the range from 500 Hz to 3 kHz. Audio-frequency receivers having a loudspeaker function can thus be used to locate cables.

When applied to telephone lines, the frequency of the higher-frequency signal should be in a range from 20 to 29 kHz. In other applications, the frequency may also be below or above this range. The frequency can then, for example, also be above 50 kHz or 100 kHz. Given suitable selection of the carrier frequency, the electrical signal can also be injected into lines of the 220/380 V power supply system, in particular the light supply system (“lighting system”), in order to locate said lines and their course.

The output capacitors which are used for injecting the signal onto the line have a capacitance of less than 100 nF, in particular of less than 50 nF, in particular of less than 30 nF, in particular of between 10 and 20 nF, or even less than 10 nF, depending on the frequency of the higher-frequency signal.

In one practical embodiment, the low-frequency signal used is a square-wave signal that has a frequency of 1 kHz and can be switched over to a frequency of 2.6 kHz, and the higher-frequency signal used is a square-wave signal having a frequency of 29 kHz. In this embodiment, output capacitors having a capacitance in the range from 10 to 20 nF are used.

Signal generation and modulation can advantageously be carried out in a processor (CPU) under complete software control without use being made of signal generators which are implemented using hardware.

The invention also makes it possible, at the audio-frequency receiver end, to evaluate the signal on the cable (which is to be tested) twice. An approximate locating operation can be carried out first of all by detecting the low-frequency signal. The line or line pair can then be accurately pinpointed by evaluating the higher-frequency signal. In this case, the built-in loudspeaker can acoustically signal that the low-frequency audio-frequency signal has been received in the receiver, and a light-emitting diode whose signal path has a bandpass filter (which has been set to the frequency of the higher-frequency signal) connected to it can signal that the higher-frequency signal has been received. This double evaluation makes it possible to increase the accuracy of locating operations, and incorrect locating operations can be reduced or avoided.

The apparatus according to the invention also makes it possible to improve the locating and pinpointing of individual lines or line pairs in the case of multiple closely adjacent lines. Specifically, it is possible to provide for a plurality of outputs of the apparatus to be intended for injecting the signal into a corresponding plurality of lines. This makes it possible to vary the signal in time slots and to switch the signal to another output in the event of any variation. By way of example, provision may be made for it to be possible to temporally vary the frequency of the higher-frequency signal in a predefined manner and to alternately switch the signal to the outputs, time slots of the signal having a constant frequency of the higher-frequency signal respectively being switched to a particular output. Alternatively, provision may also be made for the frequency of the higher-frequency signal not to be varied and, instead, for a temporally variable coding scheme, for example so-called Manchester coding (known per se), to be impressed on the signal in a prescribed manner. Such a signal having time-variable coding can then likewise be alternately switchable to the outputs, time slots of the signal having constant coding respectively being switched to a particular output.

In the practical embodiment described above, the frequency of the low-frequency signal may thus be, for example, 1 kHz, and the higher-frequency carrier signal can be varied in steps of a few kHz, for instance 3 or 4 kHz, starting from 29 kHz and can be distributed to the various outputs in the multiplex mode.

A complete apparatus for checking cabling is constructed from the audio-frequency generator (described above) and an apparatus for locating a line or a cable, such as an audio-frequency receiver. The audio-frequency receiver contains, in particular, a probe for inductively and/or capacitively injecting the signal from the cable to be located and a detection circuit that is connected to the probe.

The invention will be explained in more detail below with reference to exemplary embodiments in conjunction with the figures of the drawing, in which:

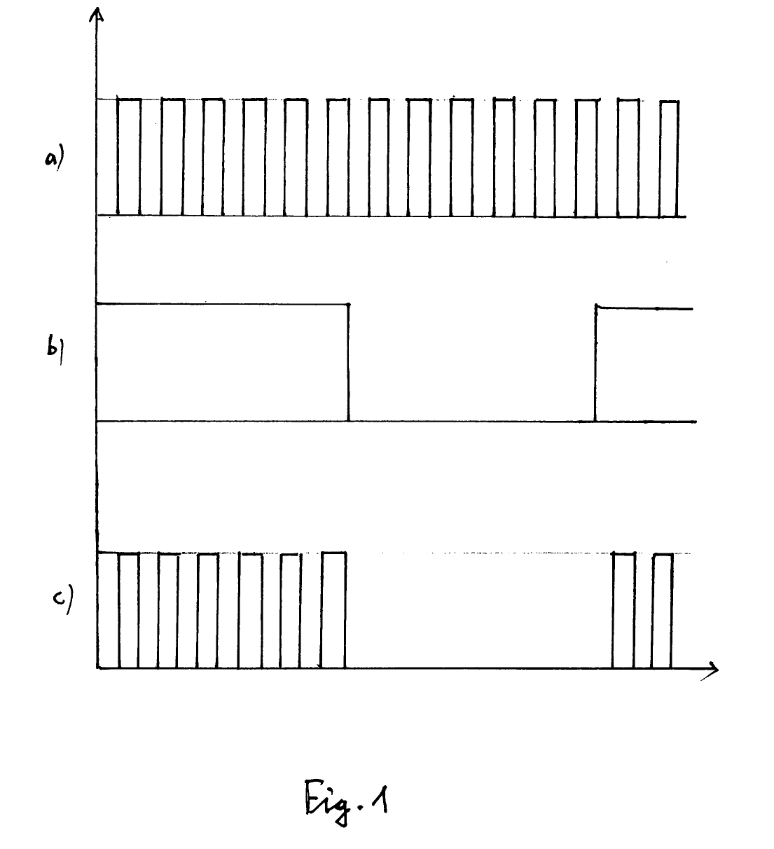

FIGS. 1a, b, c show an exemplary embodiment of signal profiles of the higher-frequency signal (a), the low-frequency signal (b) and the superimposed signal (c), as are generated in the apparatus; and

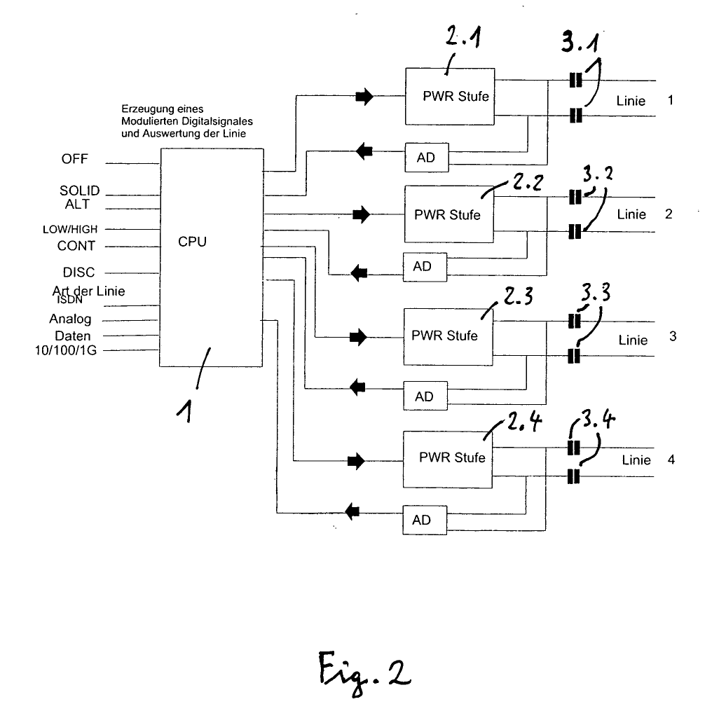

FIG. 2 shows a schematic block diagram of an embodiment of the apparatus according to the invention.

FIGS. 1a, b, c show an example of the signal profiles, in which example a square-wave higher-frequency electrical signal (a) is modulated using a likewise square-wave low-frequency signal (b) (square-wave signals are also referred to as digital signals from time to time). In the present case, modulation thus involves injecting and blanking the higher-frequency signal in time with the low-frequency signal, so that the modulated signal c) is generated. In the example shown, the frequency ratio is 1 to 12, that is to say if the low-frequency signal is a 1 kHz signal, the higher-frequency signal has a frequency of 12 kHz.

In a simple embodiment, a signal of this type is generated by a CPU with constant parameters such as frequencies and is supplied to an output to which a line is connected by means of suitable contact-connection elements such as terminals, connectors or sockets.

FIG. 2 shows a schematic block diagram of a special embodiment of the apparatus according to the invention, in which the signal can be output at four outputs (which are arranged in pairs) and can thus be injected into four line pairs which are appropriately connected and are respectively designated line 1, 2, 3 or 4. The apparatus has a CPU 1 in which the electrical signal is generated under software control and is supplied to the four outputs in the duplex mode.

In this case, the signal is subdivided into time slots of a predefined length which are respectively supplied to one of the outputs and in which the signal parameters, such as the frequencies, of the low-frequency signal and of the higher-frequency signal are respectively constant. At least one parameter, such as a frequency, is changed from one time slot to a following time slot.

The changing parameter may, for example, be the frequency of the higher-frequency signal. By way of example, a signal (as shown in FIG. 1) that has a carrier frequency of 29 kHz and an audio frequency of 1 kHz is generated by the CPU 1 in a first time slot. The signal of this first time slot is supplied to the first output of the apparatus and is thus injected into the line pair of line 1. In a second time slot that follows the first time slot, the carrier frequency is changed to 26 kHz, with the audio frequency being kept constant at 1 kHz, and the signal of this second time slot is supplied to the second output and is thus injected into the line pair of line 2. In a third time slot that follows the second time slot, the carrier frequency is changed to 23 kHz, with the audio frequency being kept constant at 1 kHz, and the signal of this third time slot is supplied to the third output and is thus injected into the line pair of line 3. In a fourth time slot that follows the third time slot, the carrier frequency is finally changed to 20 kHz, with the audio frequency being kept constant at 1 kHz, and the signal of this fourth time slot is supplied to the fourth output and is thus injected into the line pair of line 4.

Signals having a constant audio frequency but a different carrier frequency are thus applied to the four line pairs. At the receiving end, an approximate locating operation can then first of all be carried out by detecting and acoustically signalling the 1 kHz signal and then a finely defined locating operation can be effected by detecting the carrier-frequency signal. By way of example, four LEDs whose signal path respectively contains bandpass filters which have been set to the four abovementioned carrier frequencies could be arranged.

It is also possible for another parameter of the signal to be temporally variable in a predetermined manner.

Provision may also be made for the signal portions which are to be supplied to the various outputs of the apparatus to be provided with different coding schemes. The coding scheme may be of such a nature that, when square-wave signals are used within a time slot, certain pulses of the low-frequency signal or of the higher-frequency signal are suppressed. By way of example, provision may be made for certain square-wave pulses of the higher-frequency signal to be suppressed within each square-wave pulse of the low-frequency signal in FIG. 1. Selecting these square-wave pulses represents a specific coding scheme which can be detected at the receiving end and can be assigned to a specific line pair.

So-called Manchester coding which is known per se can also be used as the coding scheme.

Each of the signal paths leading from the CPU 1 to one of the outputs contains a power amplifier stage 2.1, 2.2, 2.3 and 2.4 (PWR stage) in which the electrical signal is amplified before it is output to the individual wires of the four line pairs by the output capacitors 3.1, 3.2, 3.3 and 3.4.

The keys SOLID/ALT are used to select the frequency of the low-frequency audio signal. The key SOLID is used to set a constant frequency, for example of 1 or 2.6 kHz, depending on actuation of the key. Actuating the key ALT alternately transmits two frequencies, for example the frequencies 880 Hz and 1 kHz.

The apparatus may also be used to emit a so-called NLP pulse in order to identify network connections at a hub, and network information may be received.

In addition, the apparatus also makes it possible to test the lines in a high-impedance manner, signal generation according to the invention being inactive, and a test being carried out merely passively in order to determine whether or not telephone lines are busy, which signals are received from telephone lines at which data rate and the like. For this purpose, the signals which are received on each wire of a line pair are input to an A/D converter, digitized and logically combined in a suitable manner. The output signal is evaluated by the CPU 1, and the result is indicated to the outside in a suitable manner by means of LEDs. It is possible to identify the line as voltage, short circuit, open, ISDN, DATA 10-1GB, and NLP.

The apparatus according to the invention is preferably fitted in a hand-portable test unit which, as external connection options, has an RJ45 connector, a built-in socket and crocodile clips in order to be able to connect it to telephone lines or cables and lines of another type. The audio-frequency receiver is also in the form of a hand-portable unit. As already explained above, said receiver may possibly be extended by a certain number of LEDs, said number depending on the number of line pairs which are intended to be tested at the same time. In the above exemplary embodiment shown in FIG. 2, four additional LEDs would need to be provided.

1. An apparatus for injecting electrical signals into lines or cables for test purposes, comprising:
means for generating an electrical signal by modulating a relatively higher-frequency signal with a relatively low-frequency signal; and
means for injecting the signal into one end of a line.

2. An apparatus according to claim 1, wherein
the means for generating is designed for amplitude modulation of the higher-frequency signal using the low-frequency signal.

3. An apparatus according to claim 1 or 2, wherein
the low-frequency signal and/or the higher-frequency signal is/are a square-wave signal.

4. An apparatus according to claim 1 or 2, wherein
the low-frequency signal has a frequency which, relative to the audible frequency spectrum, is in the audible range.

5. An apparatus according to claim 1 or 2, wherein
the injecting means for injecting has a plurality of outputs of the apparatus for injecting the signal into a corresponding plurality of lines.

6. An apparatus according to claim 1 or 2, wherein
at least one parameter of the signal, in particular the frequency of the higher-frequency signal, can be temporally varied in a predefined manner.

7. An apparatus according to claim 1 or 2, wherein
a temporally variable coding scheme, in particular Manchester coding, can be impressed on the signal in a prescribed manner.

8. An apparatus according to claim 5, wherein
the signal can be alternately switched to the outputs, time slots of the signal, within which the signal has constant parameters, in particular a constant frequency of the higher-frequency signal, respectively being switched to a particular output.

9. An apparatus according to claim 5, wherein
the signal can be alternately switched to the outputs, time slots of the signal having constant coding respectively being switched to a particular output.

10. An apparatus according to claim 1 or 2, wherein
the lines to be tested are telephone lines which are arranged in pairs, and, within one time slot, the signal can simultaneously be supplied to the outputs which are connected to the lines of a pair.

11. An apparatus according to claim 1 or 2, wherein
the means for generating comprises a processor, in particular a central processor unit (CPU).

12. An apparatus according to claim 1 or 2, wherein
the means for injecting comprises at least one output capacitor.

13. An apparatus according to claim 12, wherein
the output capacitor has a capacitance of less than 100 nF, in particular of less than 50 nF, in particular of less than 30 nF, in particular of between 10 and 20 nF.

14. A hand-portable test unit containing an apparatus according to claim 1 or 2.

15. An apparatus for checking cabling, comprising
an apparatus for injecting electrical signals into lines or cables for test purposes according to claim 1 or 2, and
an apparatus for locating a line or a cable, which has, in particular, a probe and a detection circuit connected to the latter.

16. A method of using an apparatus according to claim 15, comprising
injecting the electrical signal into at least one line or at least one line pair using the injecting apparatus,
locating the line by detecting the low-frequency signal, and
locating the line by detecting the higher-frequency signal.

17. A method of using an apparatus according to claim 16, wherein
in injecting the electrical signal, the signal is injected into a plurality of lines or line pairs, and
in locating by detecting the low frequency signal, only the approximate position of a line to be tested is located, and
in locating by detecting the higher frequency signal, the precise position of the line to be tested is located
